(19) United States
(12) Patent Application Publication
(10) Pub. No.: US 2002/0027900 A1
(43) Pub. Date: Mar. 7, 2002

(54) System and method for programmable spectrum management

(76) Inventors: Gudmundur Hjartarson, Nepean (CA); Mark Feeley, Kanata (CA); Jonathan Boocock, Woodlawn (CA); Andrew Deczky, Ottawa (CA); Andreas Weirich, Stittsville (CA)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/810,938

(22) Filed: Mar. 16, 2001

(30) Foreign Application Priority Data
Mar. 31, 2000 (CA) 2,303,631

(51) Int. Cl. H04L 12/54

(52) U.S. Cl. 370/352; 370/359

(57) ABSTRACT

Line interface for coupling a twisted pair telephone line with a communications network. The line interface includes a broadband analog front end for coupling the twisted pair telephone line with the line interface, and a programmable filter for filtering frequency bands to separate transmission channels, the transmission channels located in the communications network, wherein the frequency bands are determined by the programmable filter. In this manner, various services can be provided over the twisted pair telephone line.

The present invention relates generally to the field of digital subscriber line (DSL) telephone systems, and more particularly to a system and method for providing multiple systems simultaneously over a single telephone subscriber line.

### BACKGROUND OF THE INVENTION

Telephone operating companies have utilized twisted pair telephone lines to deliver telephone services to customers for over a century. There are roughly a billion twisted pair telephone lines worldwide that connect subscribers to their service providers. With the demand for increased bandwidth due to the emergence of new services such as high-speed connection to the Internet, new techniques to transmit broadband signals over the twisted pair have been developed. The twisted pair telephone line is now being used to deliver a wide variety of services using digital transmission techniques to subscribers in addition to the traditional telephony services that have always been provided.

The equipment that provides a broadband transmission capability over a twisted pair copper loop generally employs technology referred to as digital subscriber line (DSL). DSL may be defined as a technology that enables communication using any number of methods that impress a signal representing a digital bit stream onto twisted pair loops traditionally used to carry plain old telephone service (POTS) signals. There are many different types of DSL that are currently in use, including (but not limited to) integrated services digital network (ISDN), asymmetric DSL (ADSL), symmetric DSL (SDSL), high speed DSL (HDSL), and very high speed DSL (VDSL).

Some DSLs such as ADSL allow POTS to coexist with the digital transmission. For instance, ADSL operates in the frequency bands of 25 kHz to 138 kHz for upstream transmission and 138 kHz to 1104 kHz for downstream transmission. Upstream is generally defined as data flowing from a subscriber to a central office, whereas downstream is generally defined as data flowing from a central office to a subscriber. ADSL can coexist on the same twisted pair telephone line as POTS signals, which are typically in a frequency spectrum of roughly 0 to 4 kHz.

FIG. 1 illustrates traditional central office line interface architecture for deploying ADSL with POTS, represented generally by the numeral 10. A twisted pair telephone line 12 terminates at a POTS splitter 14. The POTS splitter 14 is coupled to an ADSL modem 16 and a POTS line interface 18. The POTS splitter 14 performs a frequency dependent band splitting function. The splitter 14 separates ADSL frequencies, which are greater than 25 kHz, from POTS frequencies, which are less than 4 kHz. The ADSL frequencies are directed to the ADSL modem 16 while the POTS frequencies are directed to the POTS line interface 18.

Utilizing an integrated voice and data line interface can also provide the functionality described above. In this case, the functionality can be placed onto a single line interface or line card. FIG. 2 illustrates an example of such a line card, represented by the numeral 20. A twisted pair telephone line 12 terminates at the single line card 20. The telephone line 12 is coupled to an analog front end 22. The analog front end 22 is coupled to an analog-to-digital (A/D) converter 24, which is coupled to a digital splitter 26. The digital splitter 26 is coupled to both a data network interface 28 and a voice network interface 27. All the aforementioned components are located on the line card 20.

An analog signal is received over from the twisted pair telephone line 12 at the analog front end 22. The A/D converter 24 converts the analog signal to a digital signal, which is passed though the digital splitter 26. The digital splitter 26 separates the digital signal into a POTS signal and an ADSL signal. The POTS signal is communicated to a voice network via a voice network interface 27 and the ADSL signal is communicated to a data network via the data network interface 28. Although the band splitting function is illustrated as a digital function, it can be performed using either analog or digital filtering techniques.

The introduction of high-speed data transfer over twisted pair telephone lines is desirable for a large number of consumers. Although many residences have multiple telephone numbers, it is possible to accomplish this using one twisted pair telephone line. Therefore, most residences are wired with only a single twisted pair, making deployment of ADSL data services problematic for the service provider.

Currently, there are several methods used to combat this problem. These methods typically include the use of pair gain devices or pair gain devices time division multiplex (TDM) signals from multiple users onto a single DSL signal. Therefore, each of the multiple users is assigned a timeslot in the single DSL signal during which that can transmit data. However, these solutions lack flexibility and adaptability.

It is an object of the present invention to obviate or mitigate at least some of the above-mentioned disadvantages.

### BRIEF SUMMARY OF THE INVENTION

In accordance with the present invention, there is provided a line interface for coupling a twisted pair telephone line with a communications network comprising a broadband analog front end for coupling the twisted pair telephone line with the line interface, and a programmable filter for filtering frequency bands to separate transmission channels, the transmission channels located in the communications network, wherein the frequency bands are determined by the programmable filter.

### BRIEF DESCRIPTION OF THE DRAWINGS

An embodiment of the invention will now be described by way of example only, with reference to the accompanying drawings in which:

FIG. 1 is a block diagram of a typical ADSL line interface with splitter (prior art);

FIG. 2 is a block diagram of an integrated ADSL line interface (prior art);

FIG. 3 is a block diagram of an integrated ADSL line interface according to an embodiment of the invention;

FIG. 4 is a graph illustrating different frequency bands with different, programmable band edges;

FIG. 5 is a graph illustrating ADSL and POTS frequency spectrum allocation; and

FIGS. 6A, 6B, 6C, 6D, and 6E are graphs illustrating how an embodiment of the invention can be applied to ADSL applications.

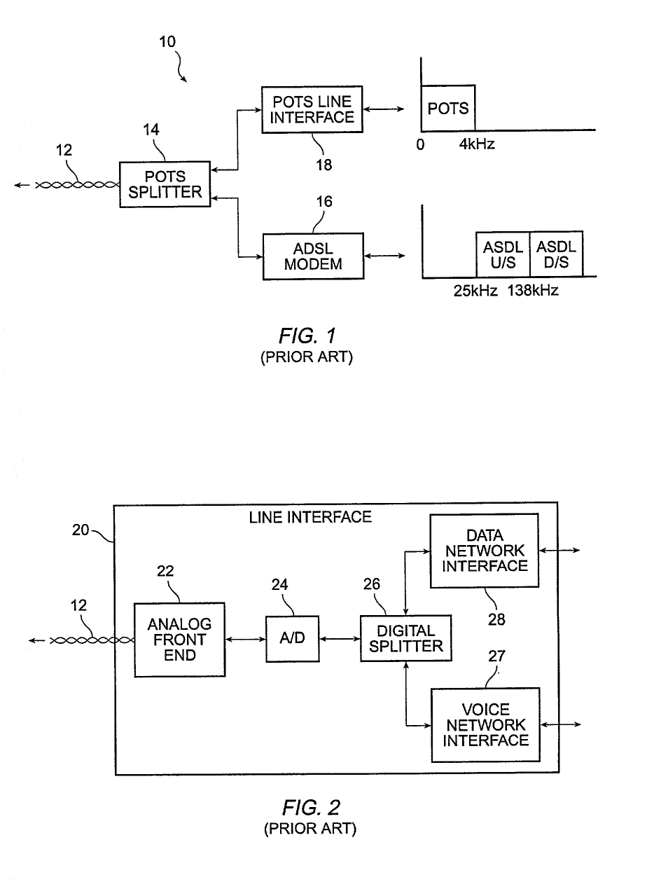

### DETAILED DESCRIPTION OF THE INVENTION

For convenience, like structures in the drawing are referred to using like numerals.

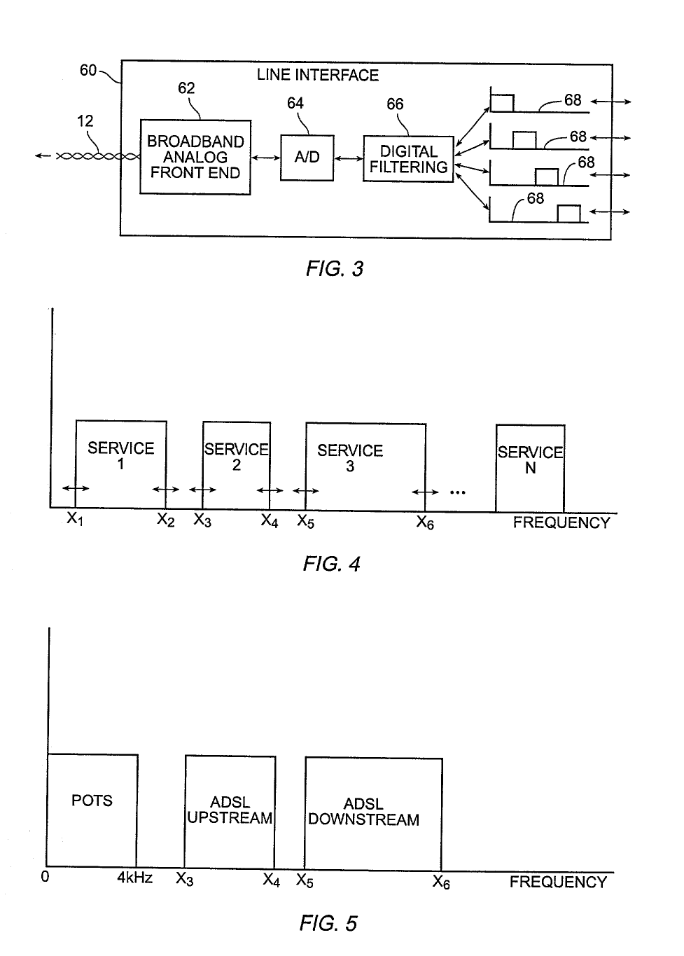

FIG. 3 shows a subscriber line interface 60. The interface 60 terminates the twisted pair telephone line 12 and is comprised of a broadband capable analog front end 62 coupled to an A/D converter 64. The output of the A/D converter 64 is coupled to a programmable filter 66, which provides a plurality of outputs 68.

A broadband signal is delivered by the twisted pair telephone line 12 and is processed by the broadband analog front end 62. The A/D converter 64 digitizes the broadband signal without any band splitting function. The programmable filter 66 is used to spectrally separate different frequency bands that can be separated into different data paths 68. Each of the data paths 68 has the capability to support different services. It is preferable that the programmable filter 66 is digital; however, it is possible to use analog filtering.

Programmable filters are known in the art and therefore will not be described in detail. The programmable filter 66 is preferably capable of being programmed using software. Using software to program the filter 66 enables the filter 66 to be easily upgraded and modified. Since the programmable filter 66 is easily modified, the number of bands provided for different services can be changed as necessary without concern for adapting the line interface 60 itself. Therefore the system control is implemented in software and the equipment can be easily maintained and updated as necessary. Since the software can be downloaded to the filter 66, the need to remove the line card 60 for the purpose of upgrading it is reduced. This versatility is aided by allowing flexibility in the utilization of bandwidth on the twisted pair telephone line 12.

This approach can be applied to any of a number of different services that can be transported over various transmission techniques occupying different frequency bands on the twisted pair. In FIG. 4 a generic form of this approach is shown. N different services are carried in N different frequency bands, each with potentially different modulation schemes. Using different modulation schemes allows support of a variety of potential services to occupy different programmable frequency bands. Different modulation schemes may be used since the filter only filters the bands and routes them to an appropriate service. The filter is programmed to send each band to its appropriate service where the required modulation and demodulation schemes are applied.

Referring once again to FIG. 3, different digital bit streams that are carried in different frequency bands are separated into different paths 68 and delivered to different service providers (not shown). The bit streams can represent either a raw digitized version of the analog signal or a fully demodulated data stream occupying a particular frequency band.

The approach described in this embodiment of the invention allows flexibility in several aspects described below. It is possible to add new services occupying new frequency bands. Different modulation schemes in each of the different frequency bands can be used to exploit channel characteristics and service requirements. Also, band edges can be moved to support introduction of new standards or enhancement of existing standards as well as for exploiting channel characteristics such as avoidance of single frequency disturbers. All of these characteristics allow different service providers to have access to the twisted pair.

In an alternate embodiment, programmable spectrum management can be used with the traditional integrated line shown FIG. 2 for increasing data throughput when the POTS line is on hook (not in use). FIG. 5 shows the frequency bands utilized for ADSL upstream, ADSL downstream, and POTS signals. The band edges for both full rate ADSL and G.Lite ADSL implementations are indicated in Table 1 below, but can be extended to cover other non-standards based versions of ADSL. The POTS signal typically ranges between 0 and 4 kHz.

TABLE 1

| | X₃ | X₄ | X₅ | X₆ |
|---|---|---|---|---|
| G.Lite | 25 kHz | 138 kHz | 138 kHz | 552 kHz |
| Full Rate | 25 kHz | 138 kHz | 25 kHz | 1104 kHz |
| Full Rate | 25 kHz | 138 kHz | 138 kHz | 1104 kHz |
| (with reduced NEXT) | | | | |

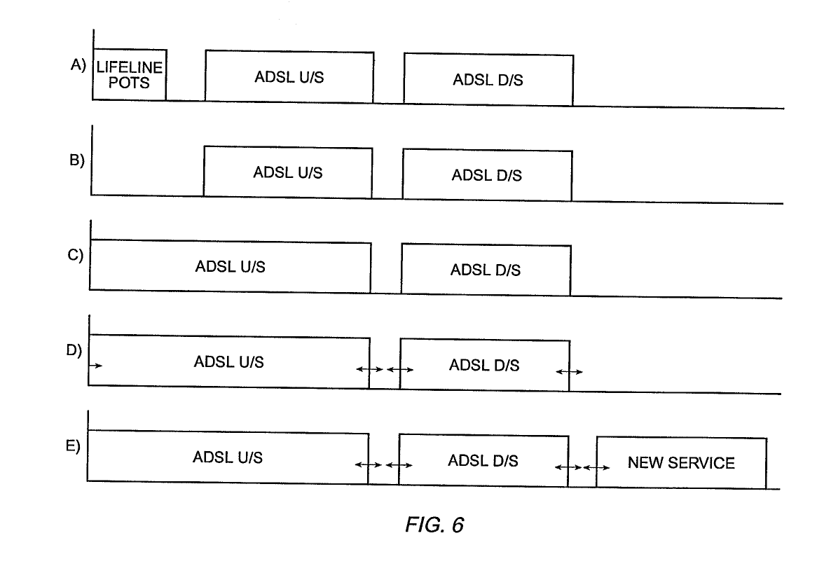

FIG. 6 illustrates how the present embodiment of the invention can be applied to ADSL applications. FIG. 6A shows typical POTS and ADSL frequency allocations. The bandwidths are the designated ones as described for FIG. 5. The 4 kHz bandwidth allocated for POTS is utilized only when the POTS interface is off hook. However, when the POTS interface is on hook the 4 kHz POTS bandwidth is not in use. It is common in the art to provide a signal indicating whether the POTS interface is on hook or off hook. By providing this signal as an input to the programmable filter, the bandwidth of an ADSL upstream signal can be extended as follows. If the POTS interface is off hook, the programmable filter extends the lower band edge of the ADSL upstream signal to include frequencies between 0 and 25 kHz as shown in FIG. 6C, thereby increasing the upstream throughput. If the POTS interface is on hook, the programmable filter returns the lower band edge of the ADSL upstream signal to 25 kHz.

Alternately, the POTS may be provided as a derived service and carried in the DSL bit stream. Such a scheme is used, for example, for pair gain systems. Therefore, as illustrated in FIG. 6B, the 4 kHz POTS bandwidth is unused. Although it is desirable to extend the lower band edge of the ADSL upstream signal to 0 kHz, it is not practical. In the event of a failure, such as a power outage or hardware error, it is necessary to revert such a derived service to a POTS service. This failsafe is often referred to as “fail to POTS mode” and provides telephone service in case of an emergency. Therefore, the 4 kHz POTS bandwidth has to be left open should such a failure occur. In order to operate properly, such a system requires a signal for indicating whether the system is operating normally or in fail to POTS mode. Therefore, providing this signal to the input of the programmable filter allows the filter to extend the lower band edge of the ADSL upstream signal. If the system is operating properly the programmable filter extends the lower edge of the ADSL upstream signal to 0 kHz. If the system is operating in fail to POTS mode, the programmable filter returns the lower band edge of the ADSL upstream signal to 25 kHz.

While the above only describes extending the lower edge of the ADSL upstream signal, it is further possible to move the upper band edge of the ADSL upstream signal as well as both band edges of the ADSL downstream signal. The moveable band edges are illustrated schematically in FIG. 6D. Therefore, the 25 kHz gain in bandwidth may be transferred to the ADSL downstream signal by moving the upper edge of the ADSL upstream signal and the lower edge of the ADSL downstream signal 25 kHz lower. Other configurations may be achieved as desired.

Furthermore, allowing dynamic movement of the band edges can be used for providing more symmetrical data rates as well as allowing the edges to be moved according to the requirements of a particular system. For example, if there is a demand for an upstream signal with a broader bandwidth, then the downstream signal bandwidth could be narrowed and vice versa. In yet another example, the bandwidths can be easily changed to accommodate changing standards by simply reprogramming the programmable filter.

Alternately, other services in addition to POTS and ADSL may be carried by the twisted pair telephone wire as shown in FIG. 6E. Such services could be added to frequency bands above the ADSL downstream signal.

Although the invention has been described with reference to certain specific embodiments, various modifications thereof will be apparent to those skilled in the art without departing from the spirit and scope of the invention as outlined in the claims appended hereto.

What is claimed is:

1. A line interface for coupling a twisted pair telephone line with a communications network, comprising:
a broadband analog front end circuit coupling said twisted pair telephone line with said line interface; and
a programmable filter coupled to receive an output signal from said broadband analog front end circuit and configured to filter frequency bands of said output signal into a plurality of separate transmission channels, wherein said plurality of separate transmission channels are associated with said communications network, and wherein said frequency bands are determined by programming said programmable filter.

2. The line interface of claim 1, wherein said communications network comprises a data network and a voice network.

3. The line interface of claim 1, further comprising:
an analog to digital converter circuit, coupled between said broadband analog front end circuit and said programmable filter, configured to convert said output signal to a digital signal, wherein said programmable filter is a digital programmable filer.

4. The line interface of claim 1, wherein said plurality of separate transmission channels are directed to a plurality of different service providers.

5. The line interface of claim 4, wherein said plurality of separate transmission channels comprise a plurality of signals with a plurality of different modulation schemes.

6. The line interface of claim 1, wherein said programmable filter is programmed with software.

7. The line interface of claim 6, wherein said software is downloaded to said programmable filter.

8. The line interface of claim 1, wherein said plurality of separate frequency bands are determined according to a protocol including at least one of POTS, ISDN, ADSL, VDSL, SDSL, IDSL, HDSL, and HDSL2.

9. The line interface of claim 8, wherein said ADSL is one of full rate ADSL, G.Lite, CAP, and QAM.

10. The line interface of claim 9, wherein said ADSL and said POTS coexist on said twisted pair telephone line.

11. The line interface of claim 10, further comprising:
a POTS detector circuit coupled to provide a POTS usage signal to said programmable filter indicating that a POTS bandwidth is in use.

12. The line interface of claim 11, wherein an ADSL bandwidth is expanded to include said POTS bandwidth when said POTS usage signal indicates that said POTS bandwidth is not in use, and said ADSL bandwidth is reduced to exclude said POTS bandwidth when said POTS usage signal indicates that said POTS bandwidth is in use.

13. The line interface of claim 11, wherein said POTS detector circuit detects whether a telephone connected to said twisted pair telephone wire is on hook or off hook.

14. The line interface of claim 11, wherein said POTS detector circuit determines if a POTS signal is communicated in said ADSL bandwidth or if said POTS signal is communicated in said POTS bandwidth.

15. A method of providing a plurality of services over a twisted pair telephone line, comprising the acts of:
receiving a broadband analog signal from said twisted pair telephone line;
filtering said broadband analog signal using a programmable filter into a plurality of separate bands; and
transmitting said plurality of separate bands to a plurality of different service providers.

16. The method of claim 15, wherein said separate bands are transmitted to said plurality of different service providers through a data network and a voice network.

17. The method of claim 15, wherein said programmable filter is upgraded by programming said filter with software.
